(19) United States
(12) Patent Application Publication
(10) Pub. No.: US 2026/0219363 A1
(43) Pub. Date: Jul. 30, 2026

(54) NEURAL RADIANCE FIELD-ENHANCED INVERSE SYNTHETIC APERTURE RADAR

(71) Applicants: The Regents of the University of California, Oakland, CA (US); Arizona State University, Tempe, AZ (US)

(72) Inventors: Md Farhan Tasnim Oshim, Amherst, MA (US); Tauhidur Rahman, San Diego, CA (US); Albert Reed, Tempe, AZ (US); Suren Jayasuriya, Tempe, AZ (US)

(21) Appl. No.: 19/038,275

(22) Filed: Jan. 27, 2025

(51) Int. Cl. G01S 7/41; G01S 13/90

(52) U.S. Cl. CPC G01S 7/417; G01S 13/9064

(57) ABSTRACT

In some implementations, there is provided a computer-implemented method comprising sampling a set of coordinates describing a volume in which an object is positioned, acquiring a plurality of true radar measurements describing a position of the object in the volume, encoding the set of coordinates to yield plurality of encoded coordinates, predicting, based on the plurality of encoded coordinates and using a machine learning model, a scattering function for the object in the volume; and generating, based on the scattering function for the object, a plurality of estimated radar measurements describing the position of the object. In some implementations, the method comprises training the machine learning model to minimize a difference between the plurality of estimated radar measurements and the plurality of true radar measurements.

### TECHNICAL FIELD

The present disclosure relates to enhancing an inverse synthetic aperture radar system (ISAR) using neural radiance fields (NeRF).

### BACKGROUND

Synthetic aperture radar (SAR) systems may be used to capture radar data of, for example, a stationary object using a mobile radar array. For example, a synthetic aperture radar system may capture multiple perspectives of a stationary object and integrate the perspectives together to yield a radar image of the object.

In the case of an Inverse SAR (ISAR) system, the inverse synthetic aperture radar may capture radar images of a moving object using a stationary radar array of the inverse synthetic aperture radar. While the synthetic aperture radar system can be used to capture radar images for large objects, the inverse synthetic aperture radar system can be used to capture radar images for smaller objects (e.g., household objects) as well. The inverse synthetic aperture radar system may also provide a benefit over synthetic aperture radar in the context of non-line-of-sight imaging. In this context, cameras and synthetic aperture radar systems may not be able to yield images of an object, but the inverse synthetic aperture radar system (which has high penetrability) can form images of an object(s) that is located out of the line of sight of the inverse synthetic aperture radar's radar array.

### SUMMARY

In some embodiments, there is provided a computer-implemented method, the method may include sampling a set of coordinates describing a volume in which an object is positioned, acquiring a plurality of true radar measurements describing a position of the object in the volume, encoding the set of coordinates to yield plurality of encoded coordinates, predicting, based on the plurality of encoded coordinates and using a machine learning model, a scattering function for the object in the volume, and generating, based on the scattering function for the object, a plurality of estimated radar measurements describing the position of the object.

In some variations, one or more features disclosed herein including one or more of the following features may be implemented as well. The machine learning model may comprise a neural radiance field network. The method may further comprise comparing the plurality of estimated radar measurements and the plurality of true radar measurements to determine at least a first difference between the plurality of estimated radar measurements and the plurality of true radar measurements, and training the machine learning model by minimizing at least the first difference between the plurality of estimated radar measurements and the plurality of true radar measurements.

In some implementations, the comparing the plurality of estimated radar measurements and the plurality of true radar measurements is performed using a loss analysis. In certain implementations, the loss analysis may include determining a mean-squared error between the plurality of estimated radar measurements and the plurality of true radar measurements. In further implementations, the method may further include communicating to a user equipment the plurality of estimated radar measurements describing the position of the object.

In some implementations, the sampling may include sampling via a spherical sampling scheme. In certain implementations, the encoding may include encoding using a multi-resolution hash encoding block. In further implementations, the plurality of encoded coordinates are provided as an input into the machine learning model to predict the scattering function for the object. In some implementations the scattering function for the object is provided as an input into a physics-based forward model to generate the plurality of estimated radar measurements.

Non-transitory computer program products (e.g., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods may be implemented by one or more (data) processors either within a single computing system or distributed among two or more computing systems. Such computing systems may be connected and may exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary flow describing the generation of estimated radar measurements describing the position of an object within a volume, in accordance with some embodiments described herein;

FIG. 2 illustrates a process used to generate estimated radar measurements describing the position of an object within a volume, in accordance with some embodiments described herein;

FIG. 3 illustrates a geometry and a sampling strategy used to generate estimated radar measurements describing the position of an object within a volume, in accordance with some embodiments described herein;

FIG. 4 illustrates a plurality of estimated radar measurements generated in the presence of Gaussian noise, in accordance with some embodiments described herein;

FIG. 5 illustrates the impact of skip angles of the imaging of two objects, in accordance with some embodiments described herein; and

FIG. 6 illustrates a block diagram of another example of a system configured to generate a plurality of estimated radar measurements, in accordance with some embodiments described herein.

### DETAILED DESCRIPTION

The synthetic aperture radar (SAR) system may lack precision when imaging certain types of objects, such as relatively small, everyday objects (e.g., water bottles, cell phones, and books). The synthetic aperture radar system may use backprojection, such that the image produced by the synthetic aperture radar system is directly correlated to the amount of energy backscattered by the imaged object. The amount of energy backscattered by a small object is necessarily smaller than that backscattered by a larger object, such that the synthetic aperture radar system may not yield clear images of a small object (or objects).

Some approaches for inverse synthetic aperture radar (ISAR) imaging include (1) time-domain backprojection (which is a technique that reconstructs images by correlating received radar data with expected echoes from target positions across a scene); the (2) Range-Doppler technique (which processes radar data collected over multiple rotations); and (3) the Polar Format Algorithm (PFA) (which directly transforms radar data from polar to Cartesian coordinates for wavefront curvature correction to compensate for distortions in received signals). However, these three approaches may face challenges, such as non-uniform motion, cluttered environments, limited measurement coverage, noise, motion compensation errors, and/or limited resolution.

Further, synthetic aperture radar systems may generally be used to image large objects (e.g., tanks and buildings), which may be stationary. But these synthetic aperture radar systems may rely on mobile radar arrays (also referred to as mobile radar array SAR) to generate radar images. The mobile radar array SAR may be mounted on a moving platform to create a large “synthetic aperture” through movement and thus generate higher resolution images of the object.

On the other hand, ISAR systems can be used to measure smaller, everyday objects. ISAR systems generate radar scans of small objects that may be moving using a stationary radar array. In some embodiments, an inverse synthetic aperture radar system may be enhanced by leveraging both machine learning (ML) and the backscattering physics of an imaged object. By embedding information regarding the backscattering physics of different objects into analysis-by-synthesis (ATS) models, the images generated by the inverse synthetic aperture radar system may be made more accurate (e.g., providing a higher-resolution or accurate image of the objects). Systems that leverage ML and physics-based analysis-by-synthesis perform better (e.g., yield more consistent and accurate radar images) in noisy environments, when imaging small objects, and when imaging sparse data. Such models need not employ high-resolution scans to generate such consistent and accurate images.

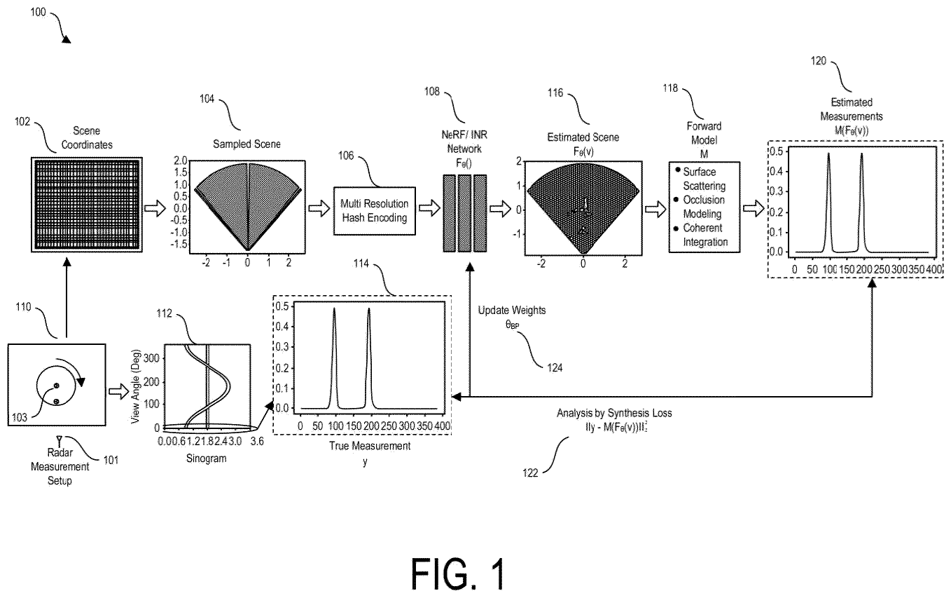

FIG. 1 illustrates an exemplary flow 100 describing the generation of estimated radar measurements describing the position of an object 103 within a volume in accordance with embodiments described herein. The flow 100 may be performed, for example, by a processor associated with a radar array 101 as described herein. The radar array 101 may be setup at 110 of flow 100. At 110 of the flow 100, the setup of the radar measurements may comprise the placement and arrangement of the radar array 101 used to capture radar measurements. For example, a radar array 101 comprising a processor may be arranged at 110 to generate (e.g., gather) scene coordinates and radar measurements. In some implementations, the radar array 101 may be positioned at a specific angular orientation relative to the object 103 in the volume of the scene. In the embodiment described by FIG. 1, the object 103 is represented by two dots disposed on a turntable which places the object 103 in motion.

The processor of the radar array 101 may be configured to generate scene coordinates 102. The scene coordinates describe a volume in which an object, such as object 103 is located or positioned. The object 103 located in the volume may be stationary or may be moving, which in the example of FIG. 1 is a rotation of the object 103. By gathering the scene coordinates 102, the flow 100 can generate a plurality of estimated radar measurements 120 that are defined with respect to the scene coordinates. The estimated radar measurements represent measurements of the position of the object 103 as predicted by a machine learning model. A machine learning model may predict the position of the object 103 based on the known backscattering physics of the object 103.

After establishing and gathering (e.g., generating) the scene coordinates 102 describing the volume in which the object 103 is disposed, the radar array 101 may be configured to sample 104 the scene in which the object is located. The object 103 may be moving (e.g., rotating, as indicated by the arrow in 110 of FIG. 1) within the scene. The sampled scene 104 comprises a plurality of radar measurements of the object 103 within the volume. The radar measurements represent the position of the object 103 as measured by the radar array 101. The radar array 101 may measure the position of the object 103 using on time of flight information determined from rays that are transmitted by the radar array 101 and scattered the object 103 before they are then received by the radar array 101.

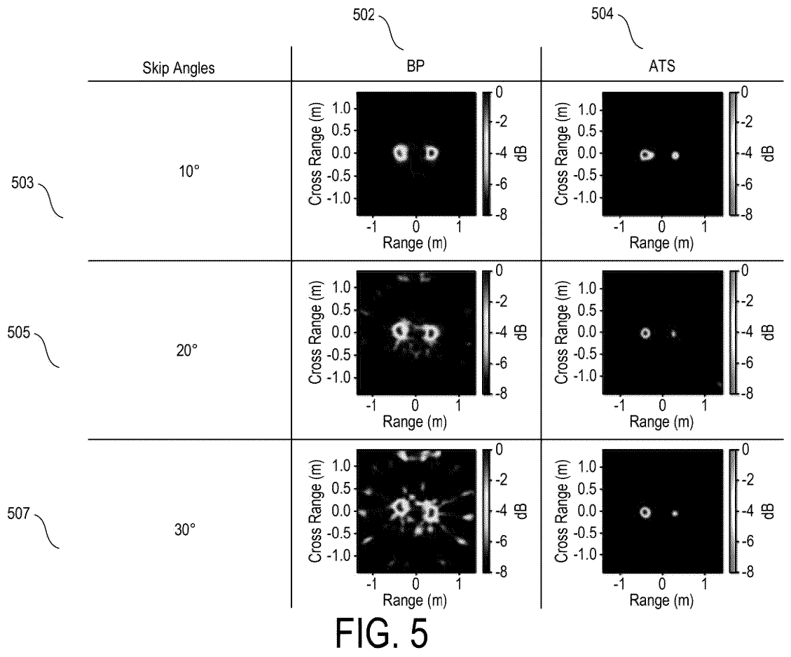

Because the object 103 is moving within the scene of FIG. 1, the plurality of radar measurements of the sampled scene 104 may capture a plurality of different views of the object 103. For example, the sampled scene 104 (which contains different views of the object 103) may be used to generate estimated radar measurements 120 of an object 103 located within a volume because, with each sampled scene 104 taken of the scene coordinates 102, slightly different angles of the scene coordinates 102 and the object 103 within the volume described by the scene coordinates are observed. The different angles of the scene coordinates 102 correspond to different views of the object 103 in the volume. The different views of the object 103 can be integrated by the system while generating estimated radar measurements 120 that describe the position of the object 103 in the volume. In some implementations, the scene coordinates 102 may be sampled using a spherical sampling scheme relative to the position of the radar array 101. As described further with respect to FIG. 5, different angles (e.g., skip angles) may be used to sample the scene containing a rotating object, such as object 103 of FIG. 1.

As the object 103 within the volume moves (e.g., rotates), the radar array 101 may perform radio frequency (RF) scans of the object 103. The backscattering (caused by the moving object) of the RF signals (which are emitted by the radar array 101) may be received (or sensed by the radar array (e.g., a receiver and/or radar processor coupled to the radar array) to yield time-of-flight data for the RF signals. This time-of-flight information associated with the rays scattered by the object 103 may then be used to generate a two-dimensional image of the moving object 103.

The sampled scene 104 may be subject to multi-resolution hash encoding 106 to provide (e.g., produce, generate, yield, etc.) a plurality of encoded coordinates describing the position of the object 103 within the volume. The plurality of encoded coordinates may comprise a plurality of positional embeddings. The plurality of encoded coordinates describing the position of the object 103 within the volume may comprise a plurality of hash-encoded measurements of the sampled coordinates. The multi-resolution hash encoding 106 may be performed by a multi-resolution hash encoding block.

The plurality of encoded coordinates are yielded by the multi-resolution hash encoding 106 of the sampled scene 104. The plurality of encoded coordinates are provided as an input into a machine learning model. For example, the ML model may be an implicit neural representation (INR) network and/or a neural radiance field (NeRF) network 108.

Neural implicit representations (INR) represent a class of neural networks (e.g. multi-layer perceptrons, or MLPs) that estimate a function to represents a signal continuously, by training on discretely represented samples of the same signal. For example, if the coordinates of an image or time series data (e.g., of an audio signal) are provided as inputs to an INR, the INR learns to generate the image or the audio signal. A neural radiance field (NeRF) is a specific sub-class of INR that is used to learn a multi-dimensional vector field. Some embodiments described herein may be implemented using NeRF networks. Further embodiments described herein may be implemented using an INR.

The neural radiance field network 108 may comprise a machine learning model that can be used to reconstruct a three-dimensional representation of a scene from a plurality of two-dimensional images.

As the object 103 moves (e.g., rotates) within the scene described by scene coordinates 102, the radar array 101 senses the object and captures a plurality of different radar scans of the object 103. For example, the radar array 101 may capture a plurality of radiofrequency scans of the object 103 moving within the scene. The radar scans of the object 103 may thus capture different views of the moving object. The neural radiance field network 108 in this example may be used to combine (e.g., integrate) all of the different radar scans of the moving object 103 performed by the radar array 101 to learn a continuous representation of a three-dimensional scene in which the object 103 is disposed. The neural radiance field network 108 thus generates a radar image of the moving object 103 by integrating all of the different views of the moving object 103 that are captured by the radar array 101.

Using on the plurality of encoded coordinates, the neural radiance field network 108 generates a complex scattering function for the object 103 in the volume. The scattering function describes how the object 103 in the volume scatters electromagnetic radiation, including radiofrequency (RF) radiation. The scattering function generated by the neural radiance field network 108 serves as an intermediate representation of the scene containing the object 103. The scattering function thus enables the generation of the estimated scene 116.

As noted, the neural radiance field network 108 may comprise a neural network, such as a multi-layer perceptron, having a plurality of fully interconnected layers (e.g., 4 fully interconnected layers, although other quantities of layers may be used as well). The neural radiance field network 108 may be configured to process encoded spatial coordinates. The layers of the neural radiance field network 108 are configured to sequentially transform the plurality of encoded coordinates, allowing the neural radiance field network 108 to learn complex mappings.

The layers of the neural radiance field network 108 may be parameterized by a plurality of weights θ_{BP}. In some implementations, to ensure stable training, the plurality of weights are initialized using Xavier initialization. The weights Opp in the neural radiance field network 108 encode the parameters that define the relationship between the input plurality of encoded coordinates (e.g., the plurality of positional embeddings) and the scattering function that is predicted by the neural radiance field network 108. Specifically, these weights OBP correspond to the learned representation of how electromagnetic (EM) radiation interacts with the object 103 in the volume of the scene at various spatial locations in the sampled volume. The weights OBP encapsulate both global and local scattering properties, including the material, geometry, and surface characteristics of the object.

In some implementations, non-linear activation functions, such as Rectified Linear Units (ReLU), may be applied after each layer of the neural radiance field network 108 to introduce non-linearity within the data representing the plurality of estimated radar measurements 120. The introduction of such nonlinearity improves the ability to capture intricate relationships within the data representing the plurality of estimated radar measurements.

For example, the neural radiance field network 108 may be implemented in PyTorch (or, e.g., some other neural network development system). The neural radiance field network 108 may be executed on at least one processor (e.g., a parallel computing platform, one or more graphics processing units (GPUs, such as NVIDIA's CUDA), and/or other types of execution environments for the ML model or the neural radiance field network 108 network).

In some implementations, the final layer of the neural radiance field network 108 may predict the scattering function for the estimated scene 116. The output of the final layer may be complex (e.g., representing both magnitude and phase information) to provide coherent processing and detailed scene reconstruction. In some implementations, the neural radiance field network 108 may compute the gradient of the scattering function with respect to the plurality of input coordinates. The gradient enables an inference of the surface normal of the object 103 in the volume. The surface normal may be used in applications, such as three-dimensional rendering, and the surface normal may be used to provide an understanding of the physical structure of the scene.

The predicted scattering function may then be used to generate (e.g., synthesize) radar measurements 120 through a differentiable radar forward model 118.

The differentiable radar forward model 118 is a deterministic differentiable mathematical function that outputs a radar baseband signal (in the form of a radargram) from the estimated three-dimensional scene from the NeRF network 108. In order to generate the three-dimensional scene, the differentiable radar forward model 118 leverages scattering models, a transmitted radar signal, and a received radar signal.

The estimated scene 116 is a reconstructed representation of the environment (e.g., scene) in which an object is located. The estimated scene 116 is generated by the machine learning model (e.g., the neural radiance field network 108) using the radar data collected in that scene. The estimated scene 116 can be used to estimate the position of the object within the volume. The estimated scene 116 may be noisy. Through this flow 100, the neural radiance field network 108 transforms spatial information into a detailed and flexible representation of the scene including the object 103.

The scattering function generated by the neural radiance field network 108 (which is based on the plurality of encoded coordinates and described the estimated scene 116) is provided as an input into a differentiable physics-based forward model 118. For example, the physics-based forward model 118 may be configured to consider how a surface of a given object 103 located within the volume described by the scene coordinates 102 reflects electromagnetic radiation. The output of the physics-based forward model 118 is a plurality of estimated radar measurements 120.

The physics-based forward model 118 encapsulates the principles of electromagnetic (EM) scattering and occlusion, leveraging a differentiable radar scattering framework for neural rendering. The physics-based forward model 118 predicts estimated radar measurements 120 based on the scene's scattering properties, incorporating transmission probabilities, scattering amplitudes, and occlusion effects. The physics-based forward model 118 approximates the scene as a collection of scatterers, with each scatterer characterized by a complex scattering function σ(x) at scene point x, where the complex scattering function is estimated by the neural radiance field network 108.

Returning again to FIG. 1, after the radar array 101 is setup at 110 of flow 100, and as the sampled scene 104 is being derived, a processor (e.g., a radar processor coupled to the radar array 101) is configured to perform or acquire a plurality of true radar measurements 114 describing the position of the object 103 within the volume described by the scene coordinates 102. True measurements 114 are recorded and observed measurements by the radar array 101. The plurality of true radar measurements 114 may be used to generate a sinogram 112. In some implementations, the true radar measurements 114 are obtained from nn virtual radar positions. For example, the true radar measurements 114 may be obtained from 360-degree positions (e.g., n=360, n=360), so as to create a circular synthetic aperture. The plurality of true radar measurements 114 comprise measurements taken at each degree of the circular synthetic aperture.

The plurality of true radar measurements are aggregated to create a two-dimensional sinogram 112. For example, the sinogram 112 may comprise a horizontal axis representing the range of the plurality of true radar measurements 114 (e.g., in meters), and may comprise a vertical axis representing the view angle of the aperture (e.g., in degrees). As shown in FIG. 1, each row of the sinogram 112 (e.g., corresponding to a constant vertical coordinate of the sinogram 112) represents a measurement of the plurality of true radar measurements 114 for the corresponding virtual radar position. For example, in FIG. 1, the circled row of the sinogram 112 (corresponding to a view angle coordinate of 0 degrees) can be used to generate the true measurement 114 that shows the radar measurement of the object taken at a 0-degree view angle. In other words, the true measurement 114 represents a one-dimensional visualization of the data of the first row of the sinogram 112.

The sinogram 112 shows that, at the 0-degree viewing angle, that the bottom dot representing the object 103 is positioned in front of (e.g., at smaller range) the top dot representing the object 103. Similar such true measurements may be similarly constructed for each vertical coordinate (e.g., row) in the sinogram 112.

Once the plurality of true radar measurements 114 are acquired, the neural radiance field network 108 can be trained to improve the plurality of estimated measurements 120. Training the network involves minimizing the loss between the estimated (e.g., synthesized) measurements 120 and the true radar measurements 114 for each scan in the sinogram 112. The plurality of estimated radar measurements 120 output by the physics-based forward model 118 are compared to the plurality of true radar measurements 114. The comparison between the plurality of estimated radar measurements 120 output by the physics-based forward model 118 and the plurality of true radar measurements 114 may be performing using a loss analysis 122. The comparison between the plurality of estimated radar measurements 120 output by the physics-based forward model 118 and the plurality of true radar measurements 114 may be configured to determine at least a first difference between the plurality of estimated radar measurements 120 and the plurality of true radar measurements 114.

The algorithm for the loss analysis may be based on an Analysis-Through-Synthesis (ATS) framework, and the algorithm is configured to measure the discrepancy between true radar measurements 114 and the generated (e.g., synthesized) measurements 120 generated from the predicted scattering function. In some implementations, the loss function used to analyze the difference between the plurality of the true radar measurements 114 and the generated radar measurements 120 is the mean squared error (MSE), expressed as:

$$Loss = {‖ y - M ( {F}_{θ} ( v ) ) ‖}_{2}^{2} , \qquad Equation 1$$

wherein y represents the value of a true radar measurement 114 and M(F_{θ}(v) represents the value of a generated radar measurement 120. Through backpropagation, the weights θ_{BP} of the neural radiance field network 108 are iteratively updated 124 to minimize the loss, ensuring that the predicted scattering function and plurality of generated radar measurements 120 closely match the true radar measurements 114. This optimization process improves the fidelity of the neural radiance field/implicit neural representation network's 108 representation with each iteration.

For example, the comparison of the plurality of estimated radar measurements 120 to the plurality of true radar measurements 114 may be used to update 124 the weights of the neural radiance field network 108. By generating a plurality of estimated radar measurements 120 using the weights of the neural radiance field network 108 that are updated at 124, an estimated scene 116 generated by the neural radiance field network 108 can be updated so that the estimated scene 116 more closely resembles the true radar measurements 114. By applying forward model 118 to estimated scene 116 computed with the updated weights, a plurality of estimated radar measurements 120 can be generated based on the updated weights. The difference between the plurality of estimated radar measurements 120 generated based on the updated weights and the plurality of true radar measurements 114 can be minimized by iterating flow 100 to repeatedly update 124 the weights of the neural radiance field network 108. Any plurality of estimated radar measurements 120 of the object made subsequent to the updating 124 of the weights of the neural radiance field/implicit neural representation network 108 will have smaller residuals relative to the plurality of true radar measurements 114.

When the weights are updated using the ATS (Analysis-Through-Synthesis) loss function, the neural radiance field network 108 adjusts its internal representation to minimize the discrepancy between the plurality of generated radar measurements 120 and the plurality of true measurements 114. This process refines the ability of the neural radiance field network 108 to accurately map the plurality of encoded coordinates (e.g., input positional embeddings) to the complex scattering function. The updates specifically enhance the ability of the neural radiance field network 108 to represent spatially resolved scattering behaviors, ensuring that the predicted scene reconstruction aligns with observed measurements.

The weights of the neural radiance field network 108 may be updated as many times as is required for the difference between the plurality of estimated radar measurements 120 and the plurality of true radar measurements 114 to be brought beneath a threshold. For example, the flow 100 of FIG. 1 may be iterated over between about five times and about one hundred times in order to minimize the difference between the plurality of estimated radar measurements 120 and the plurality of true radar measurements 114.

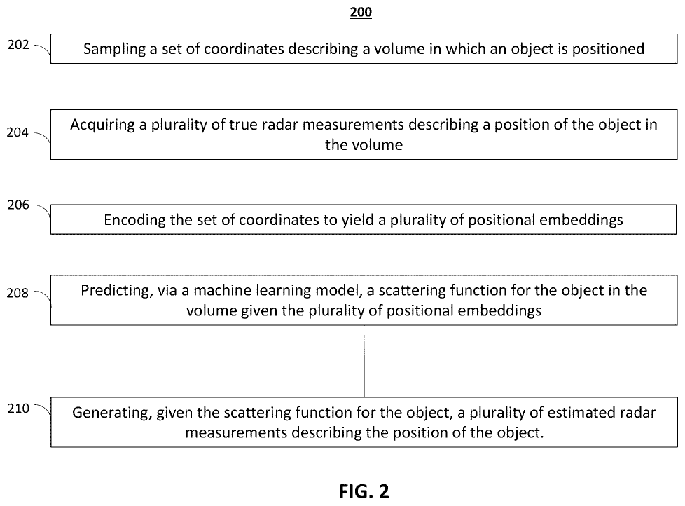

FIG. 2 illustrates a process 200 that can be employed in accordance with systems methods described herein to generate a plurality of estimated radar measurements. The process 200 may be a computer-implemented method. Alternatively, or additionally, the process 200 may be used to configure a system (at least one processor and at least one memory storing instructions that, when executed by the at least one processor, causes one or more of the operations depicted at FIG. 2). Alternatively, or additionally, the process 200 may be used to provide a non-transitory computer-readable storage medium which includes (e.g., stores) instructions which, when executed by at least one processor, causes one or more of the operations depicted at FIG. 2. For example, the process 200 of FIG. 2 may be performed by a processor coupled to a radar system (e.g., a processor coupled to a radar array, such as radar array 101 of FIG. 1). Such a radar system may have a transmitter and a receiver. The plurality of estimated radar measurements generated in accordance with the process 200 may be, for example, neural radiance field-enhanced inverse synthetic aperture radar measurements.

At 202, the process 200 may include sampling a set of coordinates describing a volume in which an object is positioned. The sampling may be performed, for example, the processor of the radar array. The sampled coordinates (e.g., sampled coordinates 102 of FIG. 1) and the sampled scene (e.g., sampled coordinated 104 of FIG. 1) are used to derive a plurality of estimated radar measurements (e.g., the plurality of estimated radar measurements 120 of FIG. 1) by processing via multi-resolution hash encoding block, a neural radiance field network, and a differentiable physics-based radar forward model (e.g., respectively, the multi-resolution hash encoding 106 of FIG. 1, the neural radiance field network 108 of FIG. 1, and the differentiable physics-based forward model 118 of FIG. 1).

The object positioned in the volume (e.g., of a scene) may be moving, such as rotating. The coordinates of the scene containing a moving (e.g., rotating) object may be sampled at regularly spaced angular intervals. In other words, the coordinates of the scene containing the rotating object may be sampled using a predetermined skip angle. The predetermined skip angle may be between about 1 degree and about 40 degrees.

At 204, the process 200 may comprise acquiring a plurality of true radar measurements describing a position of the object in the volume. The plurality of true radar measurements may be directly acquired by a radar array as reflections from real objects. The plurality of true radar measurements may be, for example, the plurality of true radar measurements 114 of FIG. 1. The plurality of true radar measurements 114 have respective angular positions corresponding to an angular position of one of the plurality of estimated radar measurements, such as the estimated radar measurements 120 of FIG. 1. This angular position determines the radar's field of view for both the true measurements and the sampled scene during each scan. The plurality of true radar measurements may be based on time-of-flight information corresponding to rays transmitted by the radar array during the sampling of the coordinates. The rays may comprise electromagnetic rays, RF signals, etc., The reflection of the transmitted rays by the moving object as sensed by the receiver of the radar array can be used create a sinogram describing the position of the object within the volume may be constructed. The sinogram describing the position of the object within the volume may be used to generate the plurality of true radar measurements.

At 206, the process 200 may comprise encoding the set of coordinates to yield a plurality of positional embeddings describing the position of the object within the volume. The set of coordinates that is encoded may be the sampled set of coordinates. The encoding may comprise multi-resolution hash encoding. The plurality of positional embeddings may describe the position of an object within a volume.

At 208, the process 200 may comprise predicting, via a machine learning model, a scattering function for the object in the volume. The scattering function predicted via a machine learning model at 208 may include information regarding how the object in the sampled volume scatters EM radiation. The scattering function may be predicted given the plurality of positional embeddings yielded by the encoding at 206. The machine learning model used to predict the scattering function for the object in the volume may be, as noted, a neural radiance field network 108, an implicit neural representation network, and/or type of ML model. The neural radiance field/implicit neural representation network may comprise a plurality of weights.

At 210, the process 200 may comprise generating a plurality of estimated radar measurements describing the position of the object. The plurality of estimated radar measurements may be generated given the scattering function for the object predicted by the machine learning model at 208. Based on the plurality of estimated radar measurements describing the position of the object, a radar image of the scene may be generated that considers the physics of the object being measured. In some implementations, the plurality of estimated radar measurements describing the position object may be communicated to a user equipment.

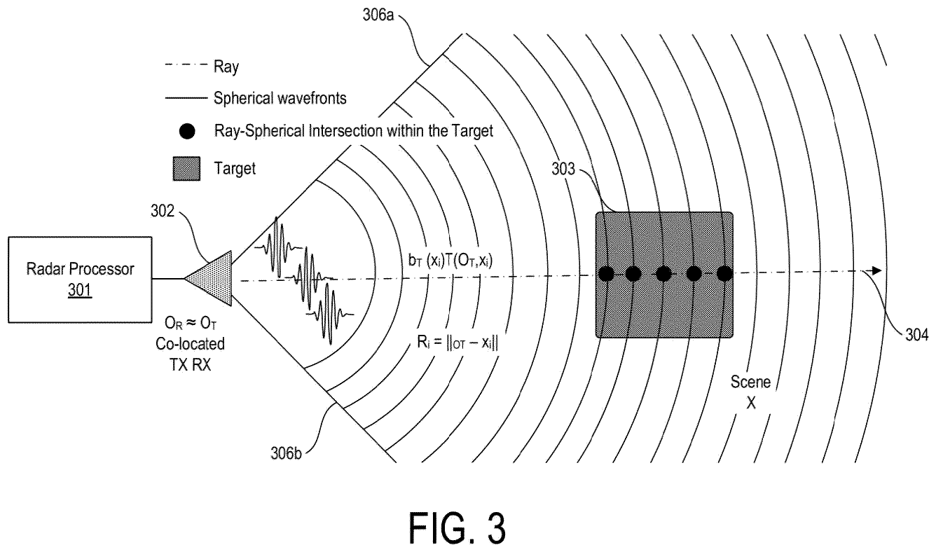

FIG. 3 illustrates a geometry and a sampling strategy used to generate estimated radar measurements describing the position of an object within a volume in accordance with embodiments described herein. A radar array 302 (e.g., a group of antennas that can be used to steer a radar beam electronically) may be coupled to a radar processor 301. The radar array may be configured to transmit a plurality of rays 304 towards a scene x. The scene x represents a volume in which a target object 303 is disposed. The radar array 302 is configured to measure the position of the target object 303 to be measured. The radar array 302 may comprise a co-located transmitter (TX) and receiver (RX). The plurality of rays 304 transmitted by the radar array 302 may comprise RF rays.

As shown in FIG. 3, a transmitted ultra-wideband (UWB) radar signal s(t) propagates through the scene. The transmitted ultra-wideband radar signal comprises the plurality of transmitted rays 304 (modeled as a Gaussian-modulated sinusoid). As shown in FIG. 3, each of the plurality of rays 304 defines a radial wavefront.

The plurality of rays 304 transmitted by the radar array 302 that lie within the beamwidth (defined by lines 306a and 306b) of the radar array sample the scene χ at the point at which the target object 303 intersects the radial wavefront of the ray. In particular, the plurality of transmitted rays 304 interact with scatterers in target object 303 based on a Lambertian scattering model L(σ(x)). The plurality of transmitted rays 304 are weighted by the directivity function b_{T}(x), representing the radar's beam pattern, and the transmission probability T(O_{T}, x), which accounts for attenuation and occlusion effects along the ray's path.

The received radar signal r (t) is synthesized as an integral over the region of interest χ, aggregating the contributions from all scatterers along the radar's line of sight. For discrete range bins, the radar range profiles are constructed by integrating scattering contributions over spherical shells defined by constant time-of-flight paths. The resulting received radar signal is expressed as:

$$r ( t = \frac{2 R}{c} ) = {\int }_{{E}_{r}}^{\cdot } T ( {o}_{T} , x ) {b}_{T} ( x ) L ( σ ( x ) ) dx , \qquad Equation 2$$

wherein Eᵣ is the sphere encompassing all points within the specific range bin (e.g., constant time of flight for the radar's forward model geometry). The direction vector b_{T}(x) is determined by the plurality of transmitted rays 304 in FIG. 3. Here, T(o, x_{T}_{ᵢ}) represents the transmission probabilities and L(σ) represents the scattered intensity. Each point along a given radial wavefront has a constant time-of-flight. Based on the constant time-of-flight for each of the radial wavefronts, the scattered of the rays by the target object 303 as sensed by the receiver of the radar array 302 can be used to reconstruct an image of the target object 303.

The scattering model addresses occlusion by computing transmission probabilities T(o, x_{T}_{ᵢ}) using an exponential attenuation factor, according to the following:

$$T ( o , {x}_{{T}_{i}} ) = {\prod }_{k < i} {e}^{- ( \vert {σ}_{k} \vert \cdot \vert {l}_{k + 1} - {l}_{k} \vert )} , \qquad Equation 3$$

wherein |σₖ | denotes the scattering coefficient magnitude, and |lₖ₊₁−lₖ | is the distance between consecutive range bins (semi-circles in FIG. 3). The transmission probability T(oT, x) represents the transmission probability between a point in the scene x and the respective origins of the transmitter oT and receiver oR of the radar array 302.

The scattered intensity L(σ) is calculated utilizing the Lambertian scattering model as follows:

$$L ( σ ) = σ \cdot \frac{{x}_{{T}_{i}} - {o}_{T}}{‖ {x}_{{T}_{i}} - {o}_{T} ‖} \cdot 2 T ( o , {x}_{{T}_{i}} ) \qquad Equation 4$$

The scattering model's spherical sampling approach ensures computational efficiency by focusing on points along the radar's beamwidth (between 306a and 306b) and range bins (semi-circles in FIG. 3). These points may be determined by intersecting the plurality of transmitted rays 304 with spheres centered at the radar's origin within the target object 303, calculated using a quadratic equation. The sampled points and their corresponding scattering properties enable the physics-based forward model 118 to simulate the radar's interaction with the scene, capturing both scattering physics and occlusion phenomena. This differentiable design allows the forward model 118 to be seamlessly integrated into the neural rendering pipeline, providing a robust foundation for optimizing scene representations through loss-based training.

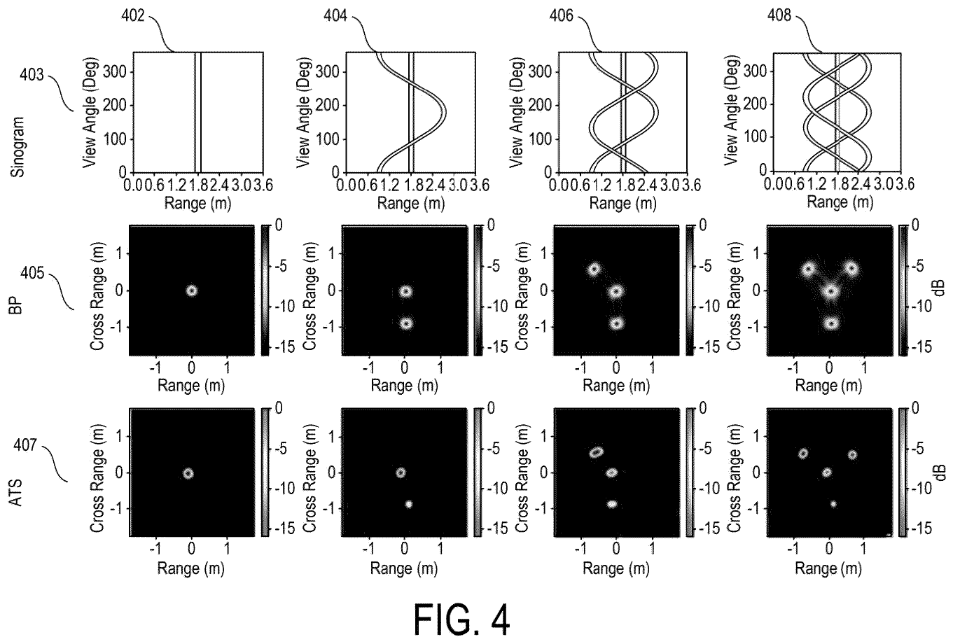

As shown in FIG. 4, loss analysis 122 may also be configured to help the inverse synthetic aperture radar systems to distinguish between meaningful radar signals and noise. Each column of FIG. 4 illustrates a different object imaging scenario. In the first column 402 of FIG. 4, one object is imaged. In the second column 404 of FIG. 4, two objects are imaged. In the third column 406 of FIG. 4, three objects are imaged. In the fourth column 408 of FIG. 4, four objects are imaged.

Each row of FIG. 4 illustrates a different technique for measuring positions of an object. In the first row 403 of FIG. 4, there are a plurality of sinograms. In the second row 405 of FIG. 4, there are a plurality of images generated by a radar system employing backprojection. In the third row 407 of FIG. 4, there are a plurality of images generated by a radar system, such as the inverse synthetic aperture radar systems described herein, that apply a loss function to the comparison of a plurality of estimated radar measurements to the plurality of true radar measurements.

As shown in row 405 of FIG. 4, in the presence of Gaussian noise, radar systems employing back projection yield signals corresponding to objects in the corners of the field of view, despite the imaged objects only being present in the center of the scene coordinates. This deficiency in such systems is present in each of the one-, two-, three-, and four-object cases, as shown in columns 402, 404, 406, and 408 of FIG. 4, respectively. This deficiency is most extreme in the four-object case, as shown in column 408 of FIG. 4. However, as shown in row 407 of FIG. 4, inverse synthetic aperture radar systems incorporating loss analysis, such as loss analysis 122 of FIG. 1, avoid generating images having signals that signify that an object is present at a location within a volume at which there is known to be no object. Instead, the analysis-by-synthesis approach that encompasses a loss function allows the inverse synthetic aperture radar systems to meaningfully distinguish between noise and radar signals.

As shown in FIG. 5, the inverse synthetic aperture radar systems employing physics-based analysis-by-synthesis approaches also provide accurate estimated radar measurements over a range of skip angles. Each row of FIG. 5 corresponds to a different skip angle used to sample a volume in which two objects are positioned. In row 503 of FIG. 5, a skip angle of 10 degrees is used to sample the volume. In row 505 of FIG. 5, a skip angle of 20 degrees is used to sample the volume. In row 507 of FIG. 5, a skip angle of 30 degrees is used to sample the volume. As shown in column 502 of FIG. 5, radar arrays employing backprojection yield noisy signals for larger skip angles. As shown in column 504 of FIG. 5, however, inverse synthetic aperture radar arrays using physics-based analysis-by-synthesis provide accurate estimated radar measurements even when large skip angles are used to sample the volume in which the measured objects are disposed. In some implementations, the skip angle used to sample the volume in which an object is disposed may be between about 1 degree and about 40 degrees.

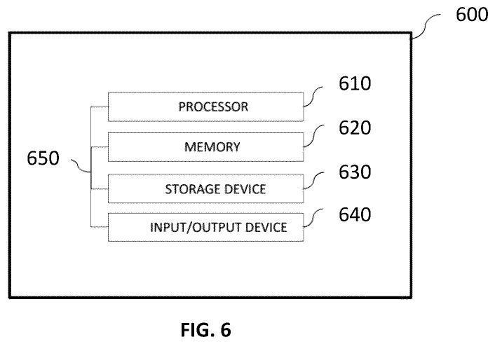

FIG. 6 depicts a diagram illustrating an example of a system 600 consistent with implementations of the current subject matter. In some implementations, the current subject matter may be configured to be implemented in a system 600. For example, the methods for generating a plurality of estimated radar measurements described herein may be implemented using the system 600. The system may include a processor 610 (such as a processor 301 of the radar array 302 of FIG. 3), a memory 620, a storage device 630, and an input/output device 640. Each of the components (e.g., processor 610, memory 620, storage device 630 and input/output device 640) may be interconnected using a system bus 650. The processor 610 may be configured to process instructions for execution within the system 600. In some implementations, the processor 610 may be a single-threaded processor. In alternate implementations, the processor 610 may be a multi-threaded processor.

The processor 610 may be further configured to process instructions stored in the memory 620 or on the storage device 630, including receiving or sending information through the input/output device 640. The memory 620 may store information within the system 600. In some implementations, the memory 620 may be a non-transitory computer-readable medium. In alternate implementations, the memory 620 may be a volatile memory unit. In yet some implementations, the memory 620 may be a non-volatile memory unit. The storage device 630 may be capable of providing mass storage for the system 600. In some implementations, the storage device 630 may be a computer-readable medium. In alternate implementations, the storage device 630 may be a floppy disk device, a hard disk device, an optical disk device, a tape device, non-volatile solid-state memory, or any other type of storage device. The input/output device 640 may be configured to provide input/output operations for the system. In some implementations, the input/output device 640 may include a keyboard and/or pointing device. In alternate implementations, the input/output device 640 may include a display unit for displaying graphical user interfaces.

The systems and methods disclosed herein may be embodied in various forms including, for example, a data processor, such as a computer that also includes a database, digital electronic circuitry, firmware, software, or in combinations of them. Moreover, the above-noted features and other aspects and principles of the present disclosed implementations may be implemented in various environments. Such environments and related applications may be specially constructed for performing the various processes and operations according to the disclosed implementations or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosed implementations, or it may be more convenient to construct a specialized apparatus or system to perform the required methods and techniques.

Although ordinal numbers such as first, second and the like may, in some situations, relate to an order; as used in a document, ordinal numbers do not necessarily imply an order. For example, ordinal numbers may be merely used to distinguish one item from another. For example, to distinguish a first event from a second event, but need not imply any chronological ordering or a fixed reference system (such that a first event in one paragraph of the description may be different from a first event in another paragraph of the description).

The foregoing description is intended to illustrate but not to limit the scope of the invention, which is defined by the scope of the appended claims. Other implementations are within the scope of the following claims.

These computer programs, which may also be referred to programs, software, software applications, applications, components, or code, include program instructions (e.g., machine instructions) for a programmable processor, and may be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium may store such program instructions non-transitorily, such as for example as would a non-transient solid-state memory or a magnetic hard drive or any equivalent storage medium. The machine-readable medium may alternatively or additionally store such machine instructions in a transient manner, such as would a processor cache or other random-access memory associated with one or more physical processor cores.

To provide for interaction with a user, the subject matter described herein may be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input.

The subject matter described herein may be implemented in a computing system that includes a back-end component, such as for example one or more data servers, or that includes a middleware component, such as for example one or more application servers, or that includes a front-end component, such as for example one or more client computers having a graphical user interface or a Web browser through which a user may interact with an implementation of the subject matter described herein, or any combination of such back-end, middleware, or front-end components. The components of the system may be interconnected by any form or medium of digital data communication, such as for example a communication network. Examples of communication networks include, but are not limited to, a local area network (“LAN”), a wide area network (“WAN”), and the Internet.

The computing system may include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the implementations described above may be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A computer-implemented method comprising:
sampling a set of coordinates describing a volume in which an object is positioned;
acquiring a plurality of true radar measurements describing a position of the object in the volume;
encoding the set of coordinates to yield plurality of encoded coordinates;
predicting, based on the plurality of encoded coordinates and using a machine learning model, a scattering function for the object in the volume; and
generating, based on the scattering function for the object, a plurality of estimated radar measurements describing the position of the object.

2. The computer-implemented method of claim 1, wherein the machine learning model comprises a neural radiance field network.

3. The computer-implemented method of claim 1, further comprising:
comparing the plurality of estimated radar measurements and the plurality of true radar measurements to determine at least a first difference between the plurality of estimated radar measurements and the plurality of true radar measurements; and
training the machine learning model by minimizing at least the first difference between the plurality of estimated radar measurements and the plurality of true radar measurements.

4. The computer-implemented method of claim 3, wherein the comparing the plurality of estimated radar measurements and the plurality of true radar measurements is performed using loss analysis.

5. The computer-implemented method of claim 4, wherein the loss analysis comprises determining a mean squared error between the plurality of estimated radar measurements and the plurality of true radar measurements.

6. The computer-implemented method of claim 1, further comprising communicating to a user equipment the plurality of estimated radar measurements describing the position of the object.

7. The computer-implemented method of claim 1, wherein the sampling comprises sampling via a spherical sampling scheme.

8. The computer-implemented method of claim 1, wherein the encoding comprises encoding using a multi-resolution hash encoding block.

9. The computer-implemented method of claim 1, wherein the plurality of encoded coordinates are provided as an input into the machine learning model to predict the scattering function for the object.

10. The computer-implemented method of claim 1, wherein the scattering function for the object is provided as an input into a physics-based forward model to generate the plurality of estimated radar measurements.

11. A system comprising:
at least one processor; and
at least one memory storing instructions that, when executed by the at least one processor, causes operations comprising:
sampling a set of coordinates describing a volume in which an object is positioned;
acquiring a plurality of true radar measurements describing a position of the object in the volume;
encoding the set of coordinates to yield plurality of encoded coordinates;
predicting, using a machine learning model, a scattering function for the object in the volume based on the plurality of encoded coordinates; and
generating, based on the scattering function for the object, a plurality of estimated radar measurements describing the position of the object.

12. The system of claim 11, wherein the machine learning model is a neural radiance field network.

13. The system of claim 11, wherein the instructions further causes operations comprising:
comparing the plurality of estimated radar measurements and the plurality of true radar measurements to determine at least a first difference between the plurality of estimated radar measurements and the plurality of true radar measurements; and
training the machine learning model by minimizing at least the first difference between the plurality of estimated radar measurements and the plurality of true radar measurements.

14. The system of claim 13, wherein the comparing the plurality of estimated radar measurements and the plurality of true radar measurements is performed using loss analysis.

15. The system of claim 14, wherein the loss analysis comprises determining a mean squared error between the plurality of estimated radar measurements and the plurality of true radar measurements.

16. The system of claim 11, further comprising communicating the plurality of estimated radar measurements describing the position of the object to a user equipment.

17. The system of claim 11, wherein the sampling comprises sampling via a spherical sampling scheme.

18. The system of claim 11, wherein the plurality of encoded coordinates are provided as an input into the machine learning model to predict the scattering function for the object.

19. The system of claim 11, wherein the scattering function for the object is provided as an input into a physics-based forward model to generate the plurality of estimated radar measurements.

20. A non-transitory computer-readable storage medium including instructions which, when executed by at least one processor, causes operations comprising:
sampling a set of coordinates describing a volume in which an object is positioned;
acquiring a plurality of true radar measurements describing a position of the object in the volume;
encoding the set of coordinates to yield plurality of encoded coordinates;
predicting, based on the plurality of encoded coordinates and using a machine learning model, a scattering function for the object in the volume; and
generating, based on the scattering function for the object, a plurality of estimated radar measurements describing the position of the object.
